(19) United States
(12) Patent Application Publication
(10) Pub. No.: US 2009/0127363 A1
(43) Pub. Date: May 21, 2009

(54) AUTOMATIC DOSAGE UNIT

(76) Inventor: Torben Malykke, Vallensbaek Strand (DK)

Correspondence Address: VEDDER PRICE P.C., 222 N. LASALLE STREET, CHICAGO, IL, 60601, US

(21) Appl. No.: 11/917,720

(22) PCT Filed: Jun. 12, 2006
(86) PCT No.: PCT/DK2006/000330

§ 371 Date: Jul. 29, 2008

(30) Foreign Application Priority Data
Jun. 14, 2005 (DK) 200500867
Mar. 23, 2006 (DK) 200600413

(51) Int. Cl. A47J 42/16; A47J 42/40; A47J 42/50

(52) U.S. Cl. 241/248; 241/258; 99/286

(57) ABSTRACT

Automatic dosage unit for dosage of a product into a collecting unit, said dosage unit comprising a grinding device, which is arranged to prepare, e.g. grind or mill, a product, and an identification device. The collecting unit comprises a handle, which is adapted to hold a container, such as a bag, and an adjustable part, and in that the identification device is arranged to identify a setting of the adjustable part of the collecting unit and on the basis of this setting dose a predetermined amount of the product into the container.

### TECHNICAL FIELD OF THE INVENTION

The present invention relates to an automatic dosage unit for dosage of a product into a collecting unit, said dosage unit comprising a grinding device, which is arranged to prepare, e.g. grind or mill, a product and activation means for activation of the dosage unit to, on the basis of the activation, dose a predetermined amount of the product into the collecting unit. The present invention also relates to an automatic dosage unit for dosage of a product into a collecting unit, said dosage unit comprising a grinding device, which is arranged to prepare, e.g. grind or mill, a product, and an identification device. The invention further relates to a storage unit for said dosage unit as well as an use of the dosage unit.

### BACKGROUND ART

Dosage units for dosage of different products are known, where the product is either pre-prepared or is being prepared in relation to the dosage itself.

Particularly in reference to the product being a food stuff, such as for example coffee, some disadvantages with the known dosage units have been shown. These dosage units could for example be coffee grinders or mills, which are adjusted to prepare i.e. grind coffee beans for use in the making of the finished coffee drink.

In recent years there has been a tendency towards coffee and coffee drinking becoming more and more popular and people often enjoy a good cup of coffee in a café or in specialised ‘Coffee Houses’. Coffee drinking has simply become a gourmet experience.

Simultaneously with this popularity increase a need has arisen in cafés, retailers, supermarkets and domestic homes alike to treat the coffee optimally from a taste point of view. This primarily viewed in light of the fact that the coffee can get a bitter taste, if it is not fresh.

It has proven particularly advantageous that, provided one grinds the coffee beans a short time before these are to be used for brewing, a good taste is achieved.

The coffee bean contains ethereal oils, which after grinding will commence an oxidation. It is by this oxidation the coffee becomes bitter. This means, the more time that passes from grinding of the coffee beans to the use of these the greater the likelihood is for a bitter taste. It must be said, that ground coffee is often sold vacuum packed for the same reason.

It has thus been shown that the storage of the ground coffee gives deterioration of the taste. In contrast to this storage of whole coffee beans does not give the same deterioration in taste as the ethereal oils lie trapped in the coffee bean itself.

A further disadvantage regarding storage of the freshly ground coffee is that it has a greasy consistency by which receptacles, magazines or storage units quickly become greasy. The ethereal oils in this greasy surface will, similar to the rest of the freshly ground coffee, oxidise after a while, which deteriorates the taste of the coffee, as mentioned above. The old coffee, which sticks to these surfaces, gives off some of the deteriorated taste to the surrounding fresh coffee.

It has furthermore been shown that if the freshly ground coffee can get in direct contact with edges or pockets where the freshly ground coffee can (and likely will) stick, this coffee can at a later point in time loosen and be transferred to the container. This will result in a significant deterioration in the coffee, which is later served to the user.

With the aforementioned popularity increase a need has arisen for the ability to prepare coffee beans and use these shortly hereafter with the freshly ground coffee being store for as short a while as possible.

A need has furthermore arisen to provide an easy option for people wishing to buy freshly ground coffee, e.g. in stores or cafés, and use it at home. Since people may wish to buy various amounts of freshly ground coffee, a need also exists to provide a solution which allows either the sellers or the buyers themselves to easily dose the freshly ground coffee into containers of various sizes without spilling coffee or grinding too much.

Thus, the matter is that existing coffee grinders require that the person using the coffee grinder first identifies the size of the container, in which the coffee is to be made, then manually estimates the amount of coffee beans which should be ground in order to obtain the sufficient volume of coffee for the container in question as well as finally that the person using the coffee grinder transfers the ground coffee beans to the container.

Existing coffee grinders on the market have furthermore the fundamental problem that the freshly ground coffee is not dosed directly into the container in which the coffee is to be used. In any event, there is some form of storage, which causes the ethereal oils, which are present in freshly ground coffee, to oxidise and the coffee thereby being perceived as “bitter”. Any form of storage of the ground coffee will therefore result in deterioration of the taste.

The above needs are relevant both when grinding coffee for use in espresso machines and when grinding coffee for other purposes, such as for use in caffetiers or for filter coffee.

### SUMMARY OF THE INVENTION

The object of the present invention is thus to provide an automatic dosage unit, which solves the aforementioned disadvantages and problems with the prior art.

It is more specifically an object of the present invention to provide an automatic dosage unit, which through activation of activation means may grind and dose a predetermined amount of a given product.

In addition it is an object of the present invention to provide an automatic dosage unit, which through identifying the size of a given container can dose a predetermined amount of a given product.

Furthermore it is an object of the present invention to provide an automatic dosage unit, which can prepare a product directly and dose the same.

It is also an object of the present invention to provide an automatic dosage unit which has a short and direct route for the product to be dosed and which decreases the product's contact with surfaces during dosage.

A further object of the present invention is to provide an automatic dosage unit, which has a short distance between grinding device and collection unit.

Moreover it is an object of the present invention to provide an automatic dosage device, which enables monitoring and controlling consumption of the product.

It is also an object with the present invention to provide an automatic dosage unit, which enables a storage unit to be locked to a dosage unit.

Moreover it is an object with the present invention to provide an automatic dosage unit which enables adjustment of preparation of a product to be dosed.

It is also an object with the present invention to provide an automatic dosage unit in which the noise during preparation of a product is significantly reduced.

The automatic dosage unit of the present invention is characterized by comprising a grinding device, which is arranged to prepare, e.g. grind or mill, a product, and activation means for activation of the dosage unit to, on the basis of the activation, dose a predetermined amount of the product into the collecting unit.

By this activation usage of the dosage unit is made very simple and it is ensured that the desired dose is obtained.

Preferably, the activation means is arranged for activation by the collecting unit. Such activation by the collecting unit ensures that the dosage unit is only activated when collecting unit is in place. It also makes use of the dosage unit easier in that only a single operation is required by the user in order to obtain a dose of product. Thus, aside from the activation means activated by the collecting unit, no other buttons or switches needs to be touched in order to obtain a dose of product.

The activation means may comprise a sensor, switch, button or other means sensitive to outside stimuli. Preferably, the activation means comprises a pressure-sensitive button. Other types of sensors or combinations or similar or different sensors may also be used in the present invention.

Preferably, a variable input signal from the activation means, optionally in combination with a setting of the automatic dosage unit, determines the predetermined amount of product to be dosed. The matter is that several different predetermined doses may be possible. Thus, in order to select a given dose, the input signal from the activation means is electronically compared to a list assigning different doses to different input signals. Such a list may, optionally, be influenced by a setting of the automatic dosage unit. For instance, different lists may be assigned to different settings of the dosage unit. In this way the various input signals may give rise to dosage of different doses according to a setting of the dosage unit. The input signal from the activation means may vary as a response to different types of activations, such as multiple quick activations or prolonged activation. For instance, an activation prolonged for a given amount of time may give rise to a double dose.

Preferably, the automatic dosage unit may comprise an adaptor part, said adaptor part comprising an outer funnel for guiding product from the automatic dosage unit into the collecting unit, and holding means for supporting the collecting unit. The holding means may help to ensure correct positioning of the collecting unit while the funnel ensures that the product is dosed precisely into the collecting unit.

The automatic dosage unit according to the present invention is also new and characterised in that the collecting unit comprises a handle, which is adapted to hold a container, such as a bag, and an adjustable part, and in that the identification device is arranged to identify a setting of the adjustable part of the collecting unit and on the basis of this setting dose a predetermined amount of the product into the container.

By this identification the possibility of using a plurality of various sizes of containers is achieved as the dosage can be performed in the correct amount in relation to the size of the container.

The invention provides a dosage unit as specified in the introduction but which recognises the size of the container.

It must be mentioned that in the following the dosage unit will primarily be described in relation to dosage and preparation of coffee, but within the idea of the invention equally it could be used for other products where the dosage of a predetermined amount to a specific size is essential for the end product.

Preferably, the collecting unit may further comprise a hollow cylinder, which fits into the container and thus acts as a funnel guiding the product into the container.

In this manner, product can be correctly guided into the container, thereby minimizing spilling.

More preferably, the collecting unit may further comprise a locking mechanism in connection with the hollow cylinder, said locking mechanism being moveable between an open position, in which a container may be placed around the hollow cylinder, and a closed position in which the container is held tightly between the locking mechanism and the hollow cylinder. By this it is obtained, that containers can be fastened to the collecting device in an easy manner.

The collecting unit may further comprise a trigger arranged at the handle and wherein the locking mechanism can be shifted between its two positions by use of the trigger. This is a preferred manner in which the locking mechanism can be controlled.

Advantageously, the adjustable part of the collecting device may comprise a displaceable rod arranged at the handle and the displaceable rod may be in the shape of a cylinder placed inside the handle.

The displaceable rod may comprise one or more markings at predetermined positions for indicating preferred positions of the rod in relation to the handle, such as positions used for indicating commonly used sizes of containers. In this manner, often used settings can be marked at the rod, thus making it easy to chose the correct setting of the rod.

Preferably, the collecting unit is made of plastic, metal or a combination thereof, preferably of a lightweight and/or durable type, such as aluminium or optionally eloxated aluminium.

The container may be a bag, such as a coffee bag, preferably made of paper or plastic. Other types of bags for coffee or other products may also be employed in the present invention.

According to a preferred embodiment of the invention the identification device may comprise a control unit to control the dosage amount of the product in relation to the size of the collection unit. The control unit facilitates a fast and precise dosage of the product for the collection unit and hereby assists with the correct dosage amount in relation to the identified collection unit.

The identification device may advantageously comprise a fastening device to receive and fasten the collection unit during dosage of the product. It is hereby possible for the user of the dosage unit to attach the collection unit with the container during the automatic dosage and for example carry out other tasks in the meantime.

According to a preferred embodiment according to the invention the dosage unit may comprise a storage unit for storage of the product so that the dosage unit thereby easily can contain an amount of the product and thus reduce refill time. In addition the product may be stored in this storage unit in a suitable way, for example the coffee beans could be hermetically sealed in whereby the taste in the beans is retained for longer than for example in an open bag. One could with advantage have several storage units, which contain different products for example different coffee beans so that they could easily be exchanged for the desired taste.

In an expedient way the dosage unit may, according to the invention, comprise a grinding device, which is arranged to prepare, i.e. grind or mill, the product. It is thereby possible to prepare the product immediately prior to dosage into the container. The grinding device is used to comminute the product whereby the dosed product, such as coffee beans, is ready for mixing with water.

According to preferred embodiment of the invention the milling device may consist of a set of conic knives comprising an outer conic knife, which mainly is funnel-shaped, and an inner conic knife which in the main is cone-shaped. Use of conic knife set has been shown to produce a very effective grinding of for example coffee beans, which is of great importance to the final taste experience. Experience shows that this type of grinding does not remove a lot of taste from the coffee beans as this type of grinding provide a quick and consistent grinding of the coffee beans.

The outer conic knife may advantageously be arranged to rotate around the inner knife. It is thus possible that the collection unit can be placed directly below the knife set and that the storage unit can similarly be placed above the knife set there as avoiding a drive shaft to the inner knife, which in the known devices take up so much space that an optimum route of the product is difficult. In this embodiment of the invention the product is moved easily by means of its weight from e.g. the storage unit to the knife set and after grinding in the knife set directly down into the collection unit, that is, a direct and short route. It is further more obtained that the product is in least possible contact with the surfaces of the dosage unit during the dosage itself. This minimal contact minimises the risk of the product sticking to the surface of the dosage unit and thereby the prepared coffee beans may potentially oxidise and become bitter which is particularly the case of the known coffee grinders.

It has furthermore proved expedient that there is a play between the inner knife and the outer knife; such play facilitates the product to move down through the conic knife set and into the collection unit during the preparation of the product.

According to an embodiment of the invention an adjustment means may be arranged to adjust the degree of preparation of the product, that is adjusting the play between the knives. Through variation in the play it is thereby possible to vary the granularity of the finished ground product and thereby to adjust the machine for various types of products.

A driving device may advantageously be arranged to rotate the outer knife. In an embodiment of the present invention the driving device is a motor which rotates the outer knife around the inner knife. The motor is placed deaxially in relation to the centre of the knife set and drives the outer knife via a transfer of power, for example a belt drive.

It has furthermore proven advantageous according to the invention if a control unit is arranged in connection with the driving device whereby the speed of rotation may be changed and thereby the preparation time of the product. This is particularly useful regarding grinding of coffee beans, as coffee beans may vary in hardness, type, roasting etc. How the grinding process has taken place can therefore be of great importance for the final taste experience of the coffee. A further advantage is that the rotation speed of the outer knife may be adjusted to the desired noise level.

The storage unit may advantageously be mounted onto the dosage unit itself and dismounted from same by a rotary motion. It is thereby obtained that the storage unit may be exchanged quickly and easily.

A locking device may advantageously be arranged to lock the storage unit to the dosage unit. This is particularly useful if the dosage unit is placed in a public place or where an authorised user wishes to secure the content of the storage unit against theft. The value of the content of a 3-litre storage unit be of high value, especially in the case of coffee beans. Hereby can e.g. a café owner, who has installed a dosage unit according to the invention, decrease the risk of waste loss and theft.

According to an embodiment of the invention a locking device may be positioned between the storage unit and an inlet to the conic knife set. By this position a compact unit is obtained and likewise a direct route from the storage unit to the knife set.

Furthermore it may be advantageous if a safety device is arranged to prevent movement of the driving device in the event the storage unit is removed from the dosage unit. Such safety device provides the advantage that the dosage unit's storage units may be changed by non-authorised users, with great safety.

It has proven particularly advantageous according to the invention if the identification of the container is provided by means of a strain gauge, micro switch, optical sensor, weighing cell, photo identification, telemeter or the like. Thereby facilitating very precise identification of the setting of the adjustable part of the collecting unit and minimising the risk of manual error. It is also possible that the dosage unit may be set-up for identification of many settings of the adjustable part.

In an embodiment according to the invention the closing device may comprise at least one opening and at least one blocking device in a way that the closing device can dose different amounts of the product by varying the size of the opening by means of the blocking device. This variation of the size of the opening depends upon the size of the collecting unit, which the dosage unit has identified. The precise predetermined amount relevant for the given container is hereby dosed.

It has furthermore proven advantageous, that the blocking device is arranged to hermetically block the opening of the closing device.

In a particularly preferred embodiment the dosage unit may comprise means for suppressing vibrations. It is hereby obtained, that the noise level associated with preparation of the product can be minimized to a level acceptable for the human ear. This is especially relevant for cafés, where the noise level associated with e.g. coffee grinders according to the prior art is very high and thereby a nuisance for patrons of the café.

According to another preferred embodiment of the invention a guiding device such as a funnel may be arranged to lead the product to the collection unit. Such a funnel is guiding the product thereby leading it as quickly as possible down into the collection unit and thereby assisting with a more precise dosage. Moreover it can be the case that the funnel may assist with directing the collection unit when attaching the collection unit to the dosage unit prior to the identification, which will be described in more detail in the following.

It has also proven advantageous if the dosage unit according to the invention is provided with an anti-static effect in a way that the product is mainly dosed without sticking to the unit.

In a preferred embodiment the anti-static effect may be provided in the shape of an outlet from the knives to the funnel in a way that the product is ensured a flow whereby the product is discharged on the way to the collection unit. It is during the grinding itself the coffee can be charged due to friction. The overall charge after grinding is still zero but the electrons are unevenly distributed so that there are many ions and it is those, which provide the ‘stickiness’. As long as good ‘stirring’ of the coffee is ensured the electrons will again distribute ‘nicely’ whereby the coffee no longer ‘sticks’.

The anti-static effect may also be provided by surface treating the areas, with which the product is in contact. These surface treatments may e.g. comprise polishing, eloxation or application of a coating.

Also, according to an embodiment of the invention a positioning device may be arranged to ensure that the collection unit is placed in a predetermined position, in which the prepared product is dosed. Hereby human errors are minimised such as, the collection unit is not held correctly during the identification of the setting of the adjustable part.

According to an advantageous embodiment of the invention a memory unit may be arranged to store information regarding the operation of the dosage unit. Hereby is obtained that the consumption of the product may be monitored in a way that the user is alerted in good time of the requirement to add a new amount of the product. Moreover the memory device may control the driving device as well as the identification device itself. A function to monitor how many times the product has been dosed and in which amounts may also be incorporated into the memory device.

Furthermore, the grinding device may be arranged for adjustment, removal or replacement by means of an adjustment tool. For instance, the grinding properties, such as the particle size obtained after grinding, may be adjusted by such an adjustment tool.

The invention also concerns an adaptor part comprising an outer funnel for guiding product from the automatic dosage unit into the collecting unit, and holding means for supporting the collecting unit. Such an adaptor part may be mounted on an automatic dosage unit according to the invention or may optionally be mounted on other dosage devices in order to make such devices capable of receiving specific collecting units, such as collecting units adapted for use in espresso machines.

Furthermore, the invention also concerns an adjustment tool for use with an automatic dosage unit according to the invention, said tool comprising means for complementary interaction with at least a lower part of the grinding device for adjusting, removing, replacing or locking in place the grinding device.

The invention also concerns a storage unit, which comprises a closing device. It is thereby possible for the user to e.g. keep different types of coffee in different storage units in a way that for example a café owner can serve different types of coffee without the need for multiple dosage units. Here the user would easily take one storage unit off and attach another.

### BRIEF DESCRIPTION OF THE DRAWINGS

The invention will be described in more detail below with reference to especially preferred embodiments and the drawing, in which

FIG. 1 is a side view of an automatic dosage unit according to the invention,

FIG. 2 is a view of the dosage unit where a section of the house has been removed and showing a collection unit placed,

FIG. 3 shows in perspective a collecting unit viewed from the side,

FIG. 4 shows in perspective a part of the dosage unit viewed diagonally from above,

FIG. 5 shows the closing device and the knife set according to the invention, viewed from above,

FIG. 6a is a cross section of the dosage device according to the invention,

FIG. 6b is a cross section of another embodiment of the dosage device according to the invention,

FIG. 7 is an exploded view of the closing device,

FIGS. 8-11 show detailed embodiments of the closing device,

FIG. 12 shows a tray for collecting spilled product in three different perspective views,

FIG. 13 shows two perspective views of an adaptor part for a dosage unit,

FIG. 14 shows an adjustment tool and part of a grinding device in unassembled state, and

FIG. 15 shows an adjustment tool and part of a grinding device in assembled state.

All the figures are highly schematic and not necessarily to scale, and they show only parts which are necessary in order to elucidate the invention, other parts being omitted or merely suggested.

### DETAILED DESCRIPTION OF THE INVENTION

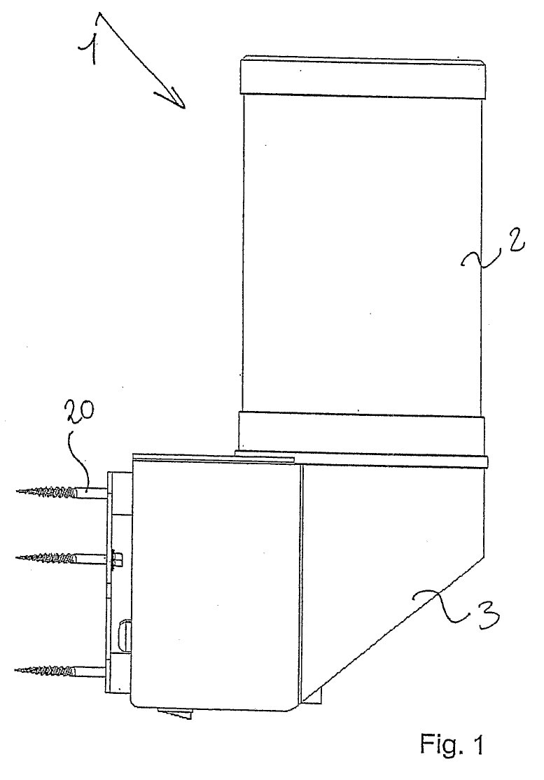

FIG. 1 shows an automatic dosage unit 1 according to the present invention, which is shown ready for mounting to a wall or similar by means of the attachment devices 20. Within the idea of the invention the dosage unit may also be adapted to be free standing on a table. The dosage unit is here shown mounted with a storage unit 2 for storage of the product for dosage.

The automatic dosage unit 1 may comprise activation means (not shown). Such activation means can for instance be in the form of a switch or button, which can be activated by touch. In a particular embodiment, the activation means is a button, which is arranged for activation by the collecting unit. This is accomplished by arranging the button at the place where the collecting unit is placed during dosage of the product into the collecting unit. In this way, correct positioning of the collecting unit will automatically activated the button and thereby lead to dosage of the product. Preferably, the button may still be activated in a number of ways, such as prolonged or repeated activation, in order to get different predetermined doses of product.

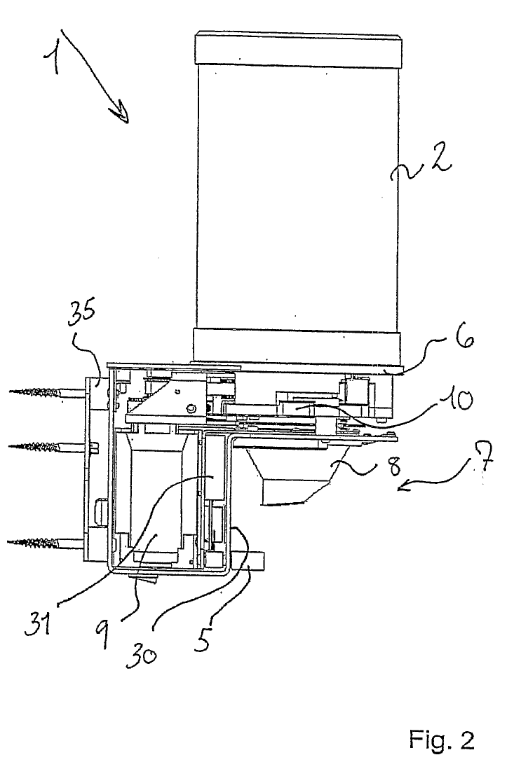

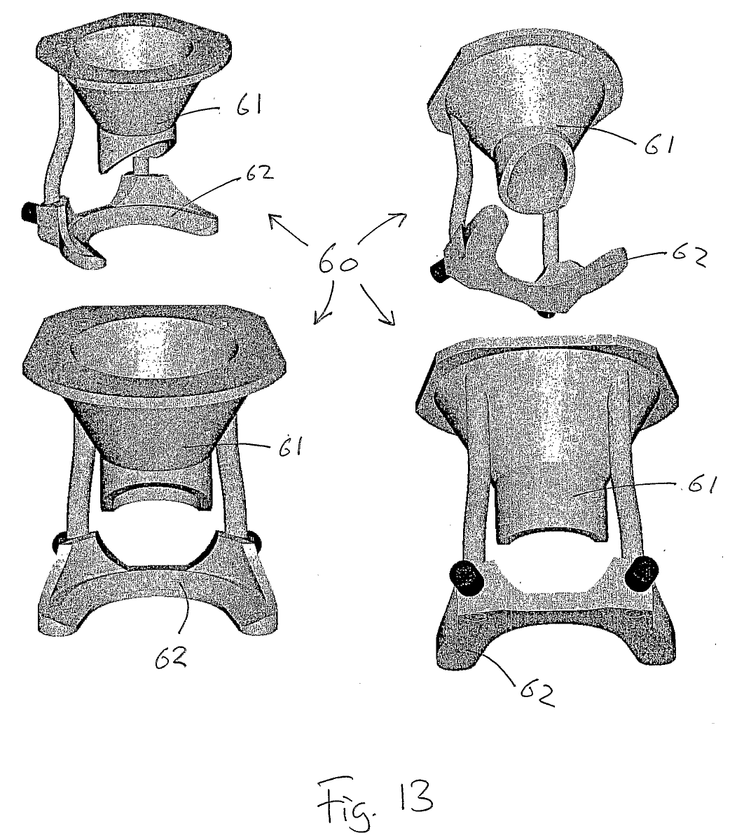

Additionally in FIG. 2 is shown an automatic dosage where the cover or house 3 is removed so that the internal parts of the dosage unit 1 are exposed. The dosage unit comprise an identification device 5, which is arranged to identify the setting of an adjustable part of the collection unit 4 (not shown in FIG. 2). This facilitates dosage of a product in correct amounts. Optionally, the dosage unit 1 may also comprise a tray for collecting spilled product. Such a tray is shown in FIG. 12 and may be placed some distance under the guiding device 8, allowing for placement of the collecting device 4 between the guiding device 8 and the tray.

As mentioned previously, the fastening device 7 comprises also a guiding device 8, here shown as a funnel, which is arranged to lead the product to the collection unit and which together with the identification unit 5 fastens the collection unit 4.

Next to the fastening device the automatic dosage unit is shown comprising a driving device 9, which is arranged to drive a grinding device 10. The grinding device 10 is here shown placed between the collection unit 4 and the closing device 6.

In FIG. 2 a means 35 of suppressing vibration is shown. These may for example consist of a rubber washer, which absorbs the vibrations from the driving device as well as the knives during operation, as to reduce the noise level. It is also the case that the primary means of decreasing vibration are arranged such as the driving device may swing in relation to the cover, which would be appreciated by a person skilled in the art. Moreover it is the case that washers, preferrably of rubber, are placed in the space between where the driving device is arranged and the cover so that the driving device is hermetically sealed to avoid airborn noise.

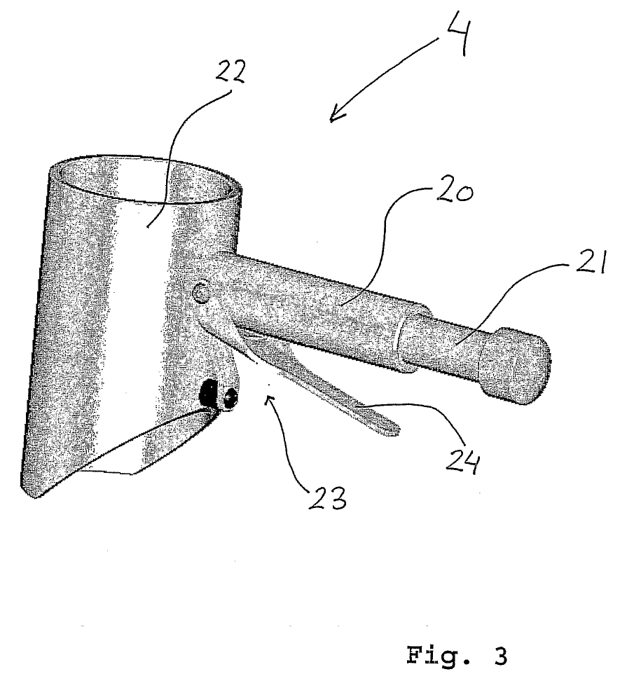

In FIG. 3 a preferred embodiment of a collecting unit 4 according to the invention is shown with a handle 20, an adjustable part 21, illustrated as a displaceable rod, a hollow cylinder 22, a locking mechanism 23 and a trigger 24.

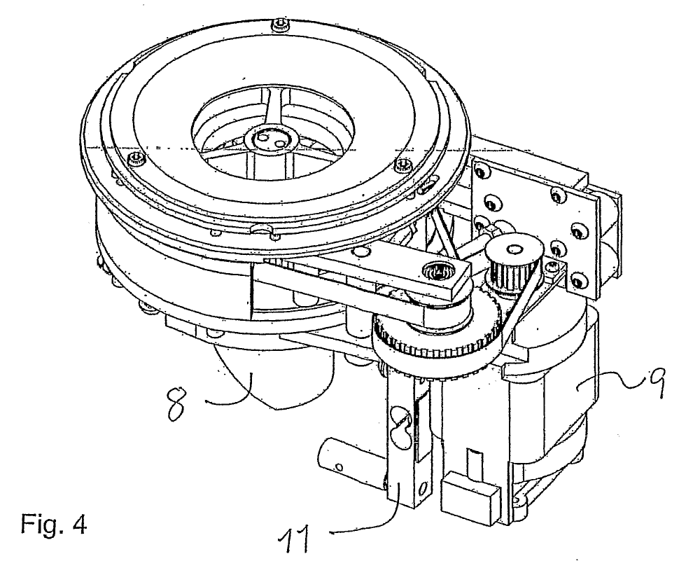

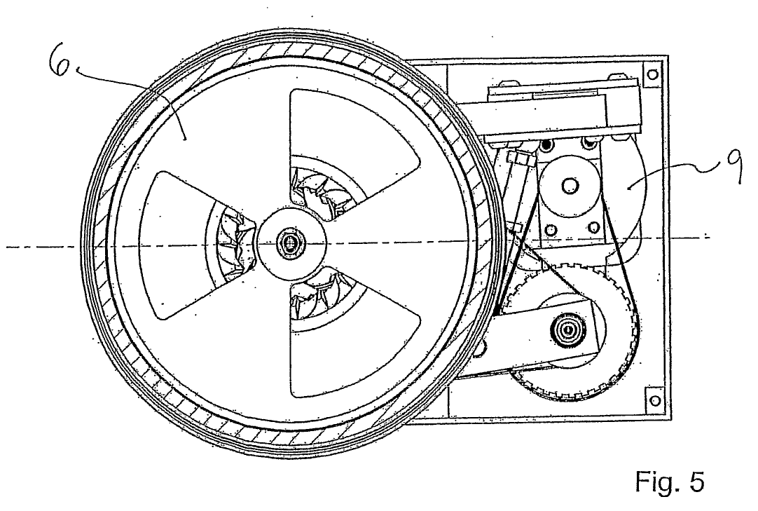

It shows on FIGS. 4 and 5 that one of the conic knives is driven by an electric motor 9 by means of a hollow drive shaft, which also serves as route.

Below the conic knives is a fastening aggregate which simultaneously ensures the positioning and fastening of the collection unit. The identification of the setting of the adjustable part of the collecting unit takes place by means of a weighing cell. The matter is, that the adjustable part of the collecting unit 4 should be adjusted by the user to a setting according to the size of container held in the collecting unit 4. In the preferred embodiment of the collecting unit 4 shown in FIG. 3, the adjustable part 21 is a rod placed inside the handle 20 of the collecting unit. When this rod is extended, i.e. pulled further out of the handle 20, the pressure experienced by the weighing cell will gradually increase as compared to when the rod remains wholly inside the handle 20. Thus, in this manner it is possible for the identification device to detect the setting of the adjustable part 21, and thereby indirectly determine the size of the container held by the collecting unit 4.

The identification of the setting of the adjustable part of the collection unit results in a drive of the motor for a suitable period of time during which the product is ground into the container.

At the same time only the correct amount of product is ground for a given setting.

The route is minimised by a hollow drive shaft and the open/close mechanism is an integral part of the storage unit.

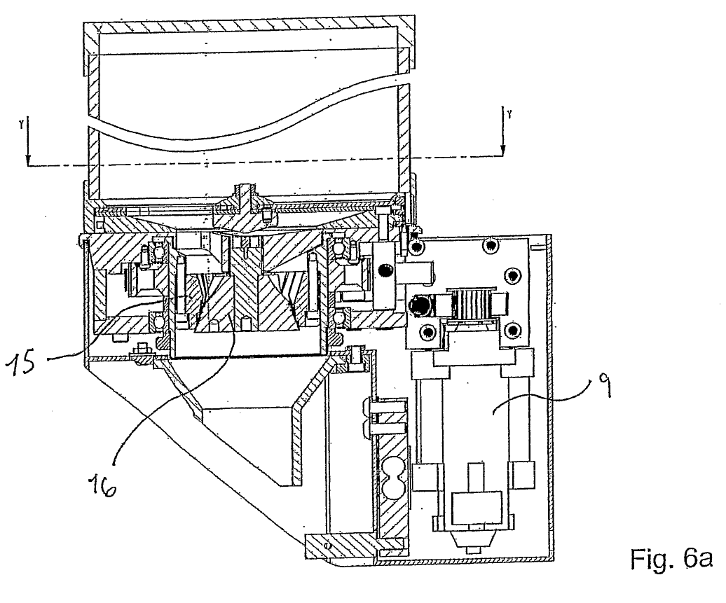

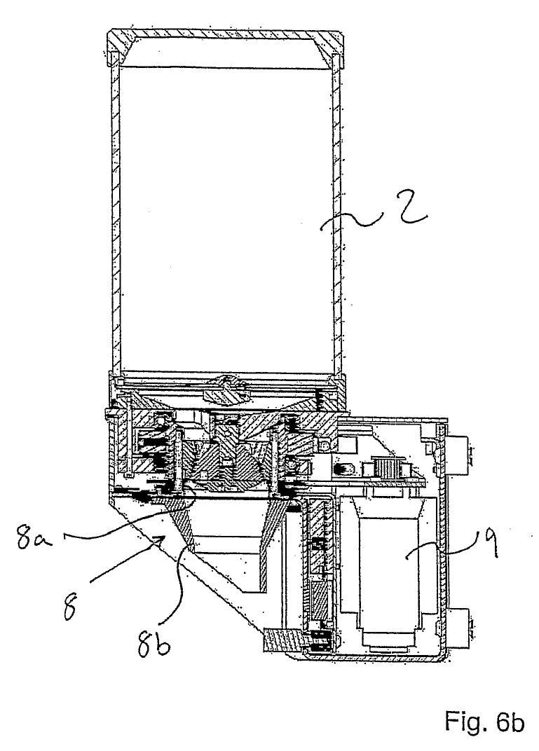

FIG. 6 shows a cross section of the dosage unit where the grinding device 10 comprises an outer conic knife 15, which in the main is funnel-shaped, and an inner conic knife 16, which in the main is cone-shaped. The outer knife 15 rotates around the inner knife 16 by means of a motor 9, which is placed deaxially in relation to the centre of the grinding device 10. Hereby obtained is that the collection unit 4 may be placed directly under the grinding unit 10 and that the collection unit 2 may also be placed over the grinding device 10. The product is thereby easily moved from the storage unit 2 to the grinding unit 10 by its own weight and after finished grinding in the grinding unit 10 directly down into the collection unit 4 and the container. Moreover, this way the product is moved the shortest possible route from storage to container and therefore touches a minimum of surface during the dosage which minimises the risk of the product sticking to the surface inside the dosage unit 1, as is the case in known units.

In this embodiment, the outer knife is driven by a belt drive on the periphery of the outer knife however it is envisioned that in other embodiments this transfer of energy could be via cogwheel or similar. Moreover, the outer knife is envisioned driven by means of pneumatics, hydraulics or similar. It is also within the idea of the invention that unutilised energy between the dosages could be stored for later use.

By grinding the product directly into the collection unit by means of a hollow drive shaft it is possible to decreasing the oxidation of the product. In other words that the motor drives the outer knife via a drive belt.

The grinding device 10 may, in another embodiment, be placed decentrally in relation the storage unit 2 in a way that the storage can take place centrally, whereby this same storage unit 2 can be used by multiple dosage units 1. Moreover, the grinding device 10 can be placed decentrally in relation to the collection unit 4, which allows for multiple collection units 4 to be held and dosed by a single product from the same dosage unit 1 and thus utilise the capacity of the dosage unit 1 better.

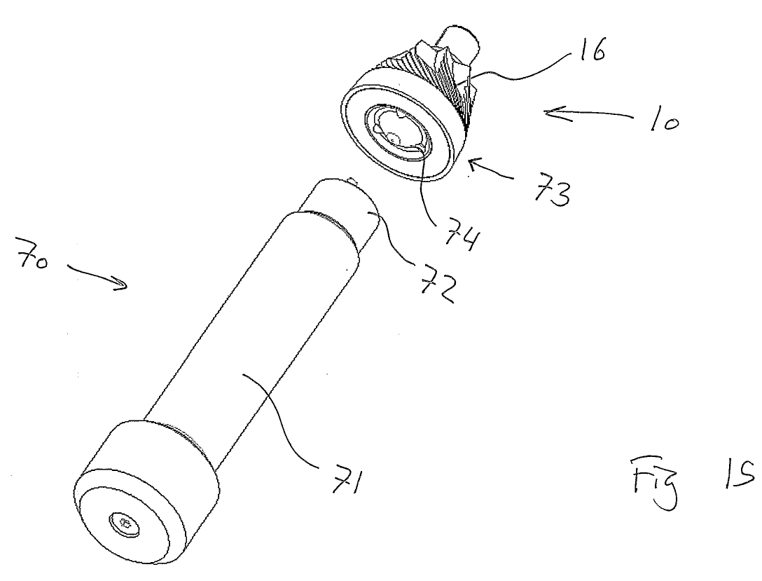

The grinding device 10 may also be removable from the automatic dosage unit 1, for instance by having a lower portion 72 with parts which are complementary to an adjustment tool 70 (see description of FIG. 14 and FIG. 15).

The automatic dosage unit 1 may in another embodiment, not shown, also be envisaged to comprise other types of grinding devices such as a fixed blade in a chamber which is moved in relation to the blade whereby the blade is cutting through the dosed amount of the product and this way comminute the product.

In another embodiment of the funnel 8, shown in FIG. 6b, it is the case that it consists of two parts; the first slanting part 8a, which is the funnel part, meaning it leads the product from the knife set down into the part 8b, whereby a funnel is formed without edges and pockets in which the freshly ground coffee can get stuck. It has thus been shown that the design of the funnel 8 as per FIG. 6b ensures the coffee against static electricity as the design of the funnel 8 provides a sliding motion for the coffee down into the collection unit where the coffee, discharges itself on the way through the funnel.

In FIG. 6b is part 8b of the funnel 8 cut off at a 45 degree angle whereby it is obtained that smaller collection units may easily be used for the dosage unit. The dosage unit is thus more flexible with regards to various sizes of the containers.

As mentioned, the storage unit is arranged to store the product, primarily coffee beans. As mentioned in the introduction, the quality of the coffee is only slowly reduced by contact with air which make is acceptable to store a certain amount.

There are however limits to how long the coffee beans can be stored before the quality is reduced. As with ground coffee, coffee beans will oxidise over time when the bag has been opened and thus have a deterioration in taste. The storage unit must therefore be of a size which allows for the unit not to require refilling too often while at the same time forcing the user to pour fresh coffee beans into the unit so no old coffee is served. A volume between 3 and 4 litres seems advantageous.

Advantageously there is no form of stagnation in the storage unit which means that there are no point within the storage unit where coffee beans are allowed to lay still when new beans are poured in. Moreover, it is preferred that the storage unit is taken off for refill as this will automatically mix the beans as well as it can be visually controlled if the unit should be cleaned.

As it must be possible to uninstall the storage unit a closing mechanism has advantageously been arranged which shuts off for the remaining beans when the storage unit is removed from the dosage unit itself.

It has proven advantageous if the storage unit is produced from a transparent material such as glass or plexi-glass.

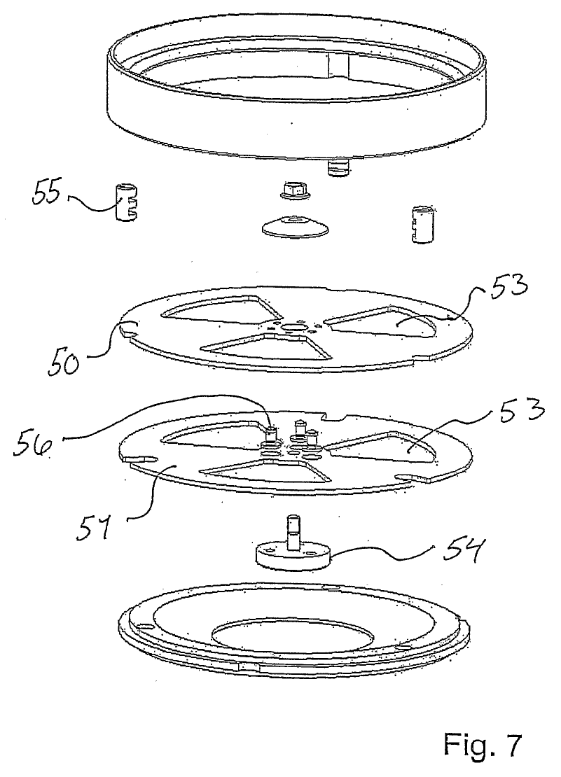

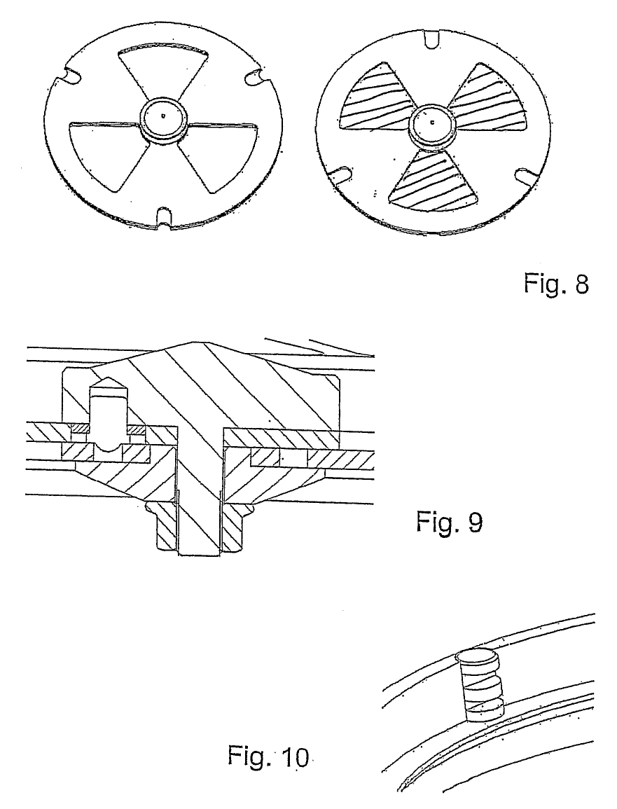

FIG. 7 shows a split picture of a closing device according to the invention. In this embodiment, the shown device consists of two plates 50, 51 which can be connected so that they can rotate in relation to each other. The two plates are arranged with openings 53, which by rotation of the two plates can be aligned so that there is an opening from the storage unit down to the dosage unit, which can be clearly viewed on FIG. 8; on the left hand side of same figure the closing device is shown completely shut.

The closing device also consists of a handle 54 whereby the two plates can be turned in relation to each other. Moreover, there are three locking sprigs 55 arranged to grip hold of the funnel upon installation.

When using the closing device it is thus the case that it is the lower plate, which can be turned freely in relation to the rest except for three arranged pressure pieces 56 on springs which provide the plate 51 to be positioned with 60 degrees in between, which is closed or open position of the holes in the plates.

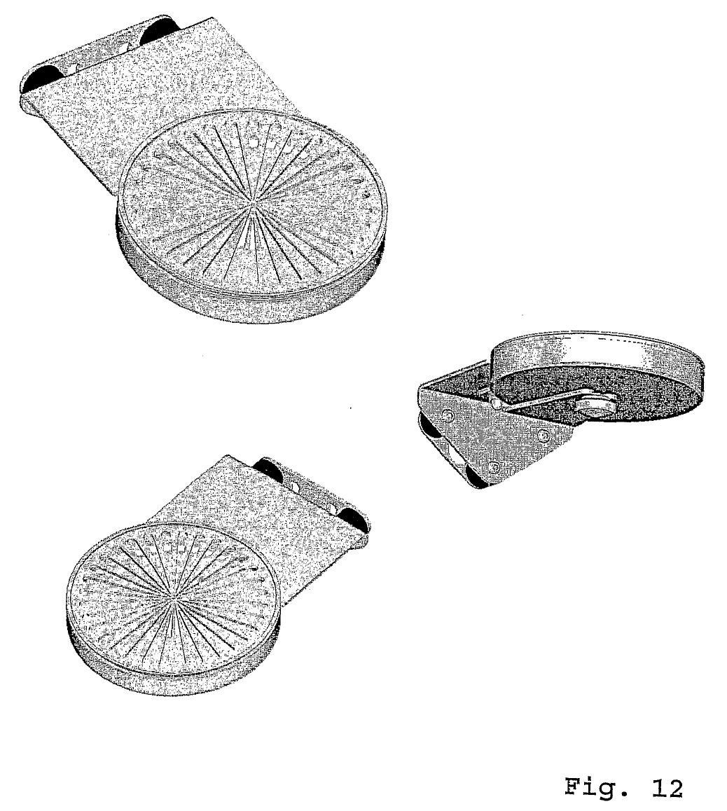

When the plates are in the open position, the holes 58 in the periphery of the plates are adjacent. This means that the connected closing device with the plates can be placed correctly by the locking sprigs, as shown in FIG. 11.

As mentioned previously, it is thus possible to turn the handle whereby the plates are closed manually. The reason why the plates close is the mutual rotation of the two plates which is caused by the bottom plate which is locked from rotation by the locking sprigs. The top plate can rotate freely in relation to the bottom plate as the top plate turns in a groove in the locking sprig. This causes also the closing device to be locked to the dosage unit.

As mentioned above it is thus obtained that in the closing mechanism a mutual rotation of the two plates happens. There are cut outs in both plates so that the plates cover each other in locked position. One of the plates is fixed in relation to the storage unit and the other plate is fixed with regards to rotation in relation to the dosage unit itself. The rotation is limited to a certain degrees by stop sprigs. It is thus obtained that the storage unit is closed when uninstalled and is opened when installed.

According to the invention it is thus the case that the closing device is an integral part of the storage unit or it can be a separate part between the storage unit and the knives. It is also the case that a steering can be arranged in connection with the closing device whereby the size, meaning the area of the opening in the plates in different rotation of the plates in relation to each other, can be varied. Herby it is achieved that the dosage (flow) of coffee beans down to the knives can be controlled on basis of the area of the openings.

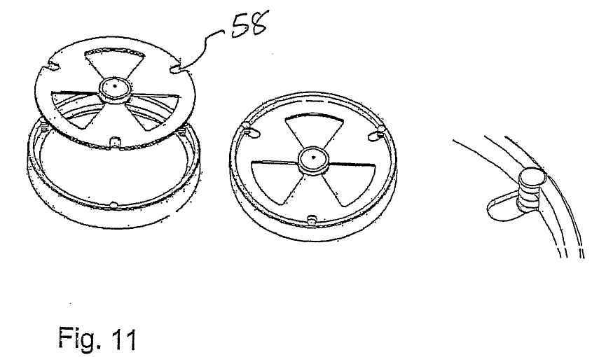

FIG. 9 shows a cut through the closing device according to the invention and FIG. 10 shows one of the three locking sprigs in an installed position.

In a preferred embodiment the dosage unit may comprise a memory unit 31, such as a computer with software, which is arranged to store information regarding the operation of the dosage unit. By fixing the collection unit 4 in position between the measuring bridge 11 and the funnel 8, the size of the collection unit 4 is identified, and the electric motor 9 is instructed by means of the software to grind the product for a given length of time. The software sorts out influences not originating from a collection unit e.g. during cleaning. In his way, the computer 31 can be pre-set for identification of different settings of the adjustable part corresponding to different sizes of containers, such as 10 g, 250 g and 500 g, respectively, and thereby the amount of coffee to be dosed for the grinding device. Such pre-setting may optionally be changed on an ongoing basis.

Moreover, the computer may collect data about how much time has passed since the storage unit has last been take off and thereby for how long the coffee has been stored in the storage unit. In this way, the computer can register the consumption of coffee and the amount of coffee most often dosed. Cleaning of the dosage unit can likewise be registered, or the computer can remind the user about cleaning the dosage unit. To be able to see said information in the computer on a display 30, a function in the identification device 5, as shown in FIG. 2, has been provided.

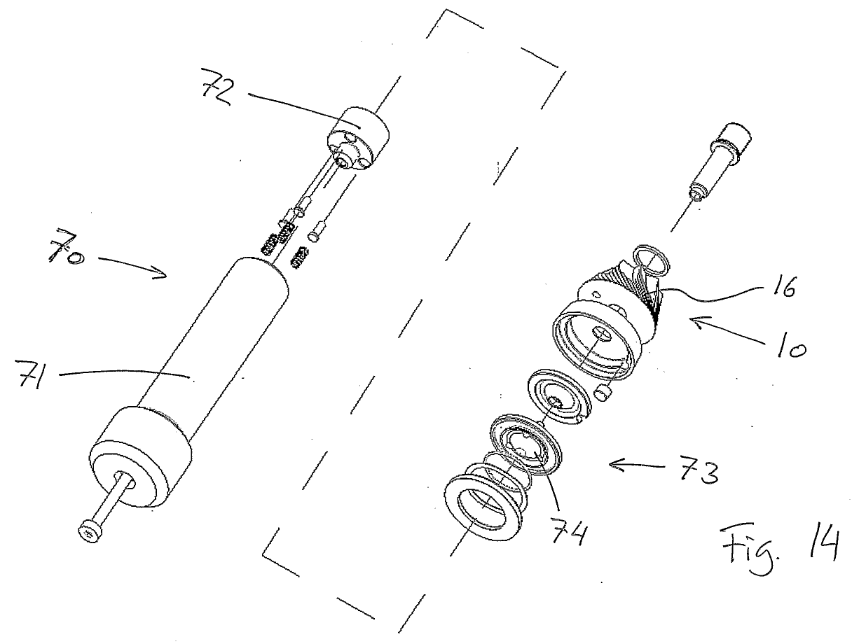

FIG. 13 shows an adaptor part 60 for a dosage unit 1 in four different perspective views. The adaptor part 60 comprises an outer funnel 61 and a holding means 62. The adaptor part 60 further comprises attachment means 63 for attaching the adaptor part 60 to a dosage unit. As previously described, the activation means may preferably be placed at the place where the collecting unit is placed during dosage of the product into the collecting unit, i.e. at or near the holding means 62. The holding means 62 may also comprise or form the activation means, for instance by the holding means 62 themselves being sensitive to the placement of a collecting unit. Said collecting unit may be a brewing handle.

FIG. 14 shows an adjustment tool 70 and part of a grinding device 10, including the inner conic knife 16, in an unassembled state. The adjustment tool 70 comprises a handle 71 and a complimentary part 72 for interaction with the grinding device 10. The grinding device 10 comprises the inner conic knife 16, an unassembled lower portion 73 and a complimentary part 74 for interaction with the adjustment tool 70. The same features are present in the assembled version of the adjustment tool 70 and part of the grinding device 10 shown in FIG. 15. The adjustment tool 70 may be used for both adjustment of the grinding device 10, e.g. to adjust the level or fineness of the grinding, and for removing or replacing the grinding device 10. The adjustment tool 70 may also be used for locking the grinding device 10 securely in place. The complimentary parts 72 and 74 of the adjustment tool 70 and the grinding device 10 may be of the plug-and-socket type or other suitable types.

The invention further relates to use of the aforementioned automatic dosage device for the preparation and dosage of coffee.

Although the aforementioned description of the invention relates preferably to coffee beans as the product it is conceivable within the idea of the invention that the automatic dosage unit may be used for various other products in the same way; both in powder- and liquid form, such as coffee powder, tea, various soft drink concentrates etc.

Although the invention above has been described in connection with preferred embodiments of the invention, it will be evident for a person skilled in the art that several modifications are conceivable without departing from the invention as defined by the following claims.

1. Automatic dosage unit for dosage of a product into a collecting unit, said dosage unit comprising a collecting unit, a grinding device, and activation means sensitive to outside stimuli for activation of the dosage unit to, on the basis of the activation, dose a predetermined amount of the product into the collecting unit.

2. Automatic dosage unit according to claim 1, wherein the activation means is arranged for activation by the collecting unit.

3. Automatic dosage unit according to claim 1 or 2, wherein the activation means comprises a sensor, switch, or button.

4. Automatic dosage unit according to any one of the claims 1 or 2, wherein the activation means comprises a pressure-sensitive button.

5. Automatic dosage unit according to claim 1, wherein a variable input signal from the activation means in combination with a setting of the automatic dosage unit, determines the predetermined amount of product to be dosed.

6. Automatic dosage unit according to claim 5, wherein said input signal from the activation means may vary as a response to different types of activations.

7. Automatic dosage unit according to claim 1, wherein the automatic dosage unit comprises an adaptor part, said adaptor part comprising a funnel for guiding product from the automatic dosage unit into the collecting unit, and holding means for supporting the collecting unit.

8. Automatic dosage unit for dosage of a product into a collecting unit, said dosage unit comprising a grinding device, and an identification device, the collecting unit comprising a handle, which is adapted to hold a container, such as a bag, and an adjustable part, and in that the identification device is arranged to identify a setting of the adjustable part of the collecting unit and on the basis of this setting dose a predetermined amount of the product into the container.

9. Automatic dosage unit according to claim 8, wherein the collecting unit further comprises a hollow cylinder, which fits into the container and thus acts as a funnel guiding the product into the container.

10. Automatic dosage unit according to claim 9,
wherein the collecting unit further comprises a locking mechanism in connection with the hollow cylinder, said locking mechanism being moveable between an open position, in which a container may be placed around the hollow cylinder, and a closed position in which the container is held tightly between the locking mechanism and the hollow cylinder.

11. Automatic dosage unit according to claim 10, wherein the collecting unit further comprises a trigger arranged at the handle arid wherein the locking mechanism can be shifted between its two positions by use of the trigger.

12. Automatic dosage unit according to claim 8, wherein the adjustable part of the collecting device comprises a displaceable rod arranged at the handle.

13. Automatic dosage unit according to claim 12, wherein the displaceable rod is in the shape of a cylinder placed inside the handle.

14. Automatic dosage unit according to claim 12 or 13, wherein the displaceable rod comprises one or more markings at predetermined positions for indicating preferred positions of the rod in relation to the handle, such as positions used for indicating commonly used sizes of containers.

15. Automatic dosage unit according to claim 8, wherein the container is a bag, such as a coffee bag, preferably made of paper or plastic.

16. Automatic dosage unit according to claim 8, wherein the identification unit comprises a control unit to control the dosage volume of the product in relation to the setting of adjustable part of the collection unit.

17. Automatic dosage unit according to claim 8, wherein the identification unit comprises a fastening device for receiving and fastening the collection unit during the dosage of the product.

18. Automatic dosage unit according to claim 8, wherein the identification of the setting of the adjustable part of the collection unit is provided by means of a strain gauge, micro switch, optical sensor, weighing cell, photo identification, telemeter or similar.

19. Automatic dosage unit according to claim 1, wherein the grinding device comprises a set of conic knives comprising an outer knife, which in the main is funnel-shaped and an inner conic knife, which in the main is cone-shaped.

20. Automatic dosage unit according to claim 19, wherein the outer conic knife is arranged to rotate around the inner knife.

21. Automatic dosage unit according to claim 19 or 20, wherein there is a play between the inner knife and the outer knife, said play facilitating the product moving down through the set of conic knives and out into the collection unit during the preparation of the product.

22. Automatic dosage unit according to claim 19, wherein an adjustment means is arranged to adjust the degree of play-between the knives.

23. Automatic dosage unit according to claim 19, wherein a driving device is arranged to drive the outer knife.

24. Automatic dosage unit according to claim 23, wherein a control unit is arranged in connection with the driving device so that the speed of rotation can be changed and thereby the time of preparation of the product.

25. Automatic dosage unit according to claim 1, wherein the dosage unit comprises a storage unit for storage of a product.

26. Automatic dosage unit according to claim 25, wherein the storage unit is installed on the dosage unit by rotary motion.

27. Automatic dosage unit according to claim 25 or 26, wherein a locking device locks the storage unit on the dosage unit.

28. Automatic dosage unit according to claim 25, wherein a closing device is placed between the storage unit and an inlet to the grinding device.

29. Automatic dosage unit according to claim 28, wherein the closing device is an integral part of the storage unit.

30. Automatic dosage unit according to claims 28 or 29, wherein the closing device comprises at least one opening and at least one blocking device so that the closing device can dose different amounts of the product by varying the size of the opening by means of the blocking device.

31. Automatic dosage unit according to claim 30, wherein the blocking device is arranged to hermetically block the opening of the closing device.

32. Automatic dosage unit according to claim 25, wherein a safety device is arranged to prevent movement of the driving device in the event the storage unit is removed from the dosage unit.

33. Automatic dosage unit according to claim 1, wherein the dosage unit comprises means for suppressing vibration.

34. Automatic dosage unit according to claim 1, wherein a guiding device, such as a funnel, is arranged to lead the product to the collection unit.

35. Automatic dosage unit according to claim 1, wherein the dosage unit is provided with anti-static effect in a way that the product in the main can be dosed without sticking to the unit.

36. Automatic dosage unit according to claim 35, wherein the anti-static effect is provided in the design of an outlet from the knives and the funnel so that the product is ensured a flow, whereby the product is discharged on the way to the collection unit.

37. Automatic dosage unit according to claim 35 or 36, wherein the anti-static effect is provided by a surface treatment of the areas, with which the product is in contact.

38. Automatic dosage unit according to claim 37, wherein the treatment of surfaces comprise polishing, eloxation or application of a coating.

39. Automatic dosage unit according to claim 1, wherein a positioning device is arranged to ensure that the collection unit is placed in a predetermined position, in which position the prepared product is dosed.

40. Automatic dosage unit according to claim 1, wherein a memory unit is arranged to store information concerning the operation of the dosage unit.

41. Automatic dosage unit according to claim 1, wherein the collecting unit is made of plastic, metal or a combination thereof, preferably of a light-weight and/or durable type, such as aluminium or optionally eloxated aluminium.

42. Automatic dosage unit according to claim 1, wherein the grinding device is arranged for adjustment, removal, replacement or locking in place by means of an adjustment tool.

43. An adaptor part for use in an automatic dosage unit according to claim 1, said adaptor part comprising a funnel for guiding product from the automatic dosage unit into the collecting unit, and holding means for supporting the collecting unit.

44. An adjustment tool for use with an automatic dosage unit according to claim 1, said tool comprising means for complementary interaction with at least a lower part of the grinding device for adjusting, removing, replacing or locking in place the grinding device.

45. Storage unit for automatic dosage unit according to claim 1, which comprise a closing device.

46. Collecting unit for use in an automatic dosage unit according to claim 1, said collecting unit comprises a handle, which is adapted to hold a container, such as a bag, and an adjustable part.

47. (canceled)
